(19) United States
(12) Patent Application Publication
(10) Pub. No.: US 2006/0171092 A1
(43) Pub. Date: Aug. 3, 2006

(54) Ring mounted combination whistle and stopwatch

(76) Inventors: Brian Corcoran, Ridgewood, NJ (US); Michael Nally, Ridgewood, NJ (US); David Rossi, Newton, NJ (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 11/244,306

(22) Filed: Oct. 5, 2005

Related U.S. Application Data
(60) Provisional application No. 60/616,084, filed on Oct. 5, 2004.
(60) Provisional application No. 60/656,471, filed on Feb. 25, 2005.

(51) Int. Cl. G04F 10/00; H01H 47/20

(52) U.S. Cl. 361/182; 702/178

(57) ABSTRACT

A combination featuring a housing supporting a clock circuit with an internal clock, and an audio frequency generating apparatus integrated into the housing, in which the clock circuit is manually operated only in a first preferred embodiment is disclosed; while the clock circuit is responsive to a pre-selected frequency of the audio frequency generating apparatus in a second preferred embodiment is further disclosed. Preferably, the audio frequency generating apparatus takes the form of a whistle that incorporates a plurality of tone notches. Each tone notch produces an audible frequency slightly out of phase with the audible frequencies produced by the remaining tone notches. When a user selects an automatic mode for operating the combination in the second preferred embodiment, one of the plurality of frequencies produced by the tone notches (having been previously selected) is sampled by the clock circuit to activate and deactivate the internal clock.

### CROSS REFERENCE TO RELATED APPLICATION

This application claims the benefit of copending U.S. Provisional Patent Application Ser. No. 60/616,084 entitled RING MOUNTED COMBINATION WHISTLE AND STOPWATCH filed Oct. 5, 2004 and copending U.S. Provisional Patent Application Ser. No. 60/656,471 entitled RING MOUNTED COMBINATION WHISTLE AND STOPWATCH filed Feb. 25, 2005.

### FIELD OF THE INVENTION

The present invention relates to a combination timing device and audio alert apparatus. More particularly, but not by way of limitation, the present invention relates to a combination whistle and stopwatch, and in particular a combination whistle and stopwatch, wherein the stopwatch and whistle operate independently and manually in a first embodiment; and further wherein, a second embodiment incorporates a stopwatch that is responsive to the whistle for starting or stopping the stopwatch.

### BACKGROUND OF THE INVENTION

Both stopwatches and whistles are instruments used by officials during the officiating of sporting events such as basketball, rugby, soccer, and football. The whistles often contain a cork ball, referred to as a “pea,” which periodically disrupts passage of air from escaping a tone notch. The disruption causes an intermittent suppression of the sound emitting from the whistle, causing the resulting vibrato effect. When the pea gets stuck in the tone notch, or becomes frozen within the air chamber, the whistle ceases to function.

Stopwatches used by the officials are often worn around their necks dangling from a cord, or with the cord wrapped around their wrist and hand carried in their hands, or carried in a pocket. When worn around the neck, the stopwatch can become quite uncomfortable. Carrying the stopwatch in their hands makes it difficult to handle the ball, which from time to time the officials are required to do, and carrying the stopwatch in their pocket makes access to the instrument less than desirable.

Pressures from coaches, players, and fans place officials under great scrutiny. Failure of an infraction being officially called, due to a defective whistle, or a mismatch between a clock seen by the coaches, players, and fans; and the official clock controlled by an official (caused by an inadvertent stoppage or non-stoppage of the official clock by the official) can make a difference in the outcome of the game. As such, challenges remain and a need persists for improvements in techniques used for the production of whistles and stopwatches, and in particular to more convenient, dependable, and less awkward whistles and stopwatches, to which the present invention is directed.

### SUMMARY OF THE INVENTION

In accordance with preferred embodiments, a combination comprising a housing supporting a clock circuit, and an audio frequency generating apparatus integrated into the housing, wherein the clock circuit is responsive to manual inputs in a first claimed embodiment, and responsive to a pre-selected frequency of the audio frequency generating apparatus in a second claimed embodiment.

In the first embodiment, the clock circuit includes: a control circuit (“controller”) that includes an internal clock (“IC”); a manual clock start/stop/reset “SSR” circuit, with which a user may manually control the functions of the controller, which interacts with the IC to: place the IC in a count-up mode, or a count-down mode; pause the IC, or resume the IC; or to reset or stop the IC; and a display for showing the status of the clock circuit.

In addition to the functions and features of the first embodiment, the second embodiment further includes: a frequency pick-up device responsive to a selected frequency provided by the audio frequency generating apparatus; and a mode select switch (MSS). The frequency pick-up device communicates with an auto start clock circuit, which interacts with the controller that includes the IC, to automate select functions of the clock circuit. By depressing the center of the MSS once, the controller directs a display driver (present in both the first and second embodiments), to switch between the chronographic watch mode, and the stopwatch mode, depending on which mode the clock is then operating. When the clock is operating in the stopwatch mode, the SSR operates in substantially the same manner as described hereinabove for the first embodiment. When the clock is operating in the chronographic watch mode, the MSS and the SSR operate in conjunction to set the: hours; minutes; alarm time; month; day; year; and time zone.

These and various other features and advantages which characterize the claimed invention will be apparent from reading the following detailed description and a review of the associated drawings.

### BRIEF DESCRIPTION OF THE DRAWINGS

FIG. 1 shows an elevational front view of a whistle and stopwatch combination of the present invention.

FIG. 2 provides a perspective, elevational side view of the whistle and stopwatch combination of the present invention of FIG. 1.

FIG. 3 illustrates a perspective view of the whistle and stopwatch combination of the present invention of FIG. 1.

FIG. 4 is a block diagram of a clock circuit of the whistle and stopwatch combination of the present invention.

FIG. 5 exemplifies the whistle and stopwatch combination of the present invention of FIG. 1, illustrated in an ordinary use by a user of the present invention.

FIG. 6 shows an elevational front view of a stopwatch including a whistle cradle constituting an alternate embodiment of the present invention.

FIG. 7 provides a perspective, elevational side view of the alternative embodiment of FIG. 6.

FIG. 8 illustrates a perspective view of the alternate embodiment of the alternative embodiment of FIG. 6.

FIG. 9 provides a partial cross-sectional, elevational view of a whistle snap retainer and retention feature of the alternate embodiment of the present invention of FIG. 7.

FIG. 10 exemplifies the whistle and stopwatch combination of the alternate embodiment of the present invention of FIG. 6, illustrated in an ordinary use by a user of the present invention.

### DESCRIPTION OF THE PREFERRED EMBODIMENTS

Before explaining the present invention in detail, it is important to understand that the invention is not limited in its application to the details of the construction illustrated, or by the steps of construction inherently present by way of illustration of the appended drawings. The invention is capable of other embodiments and of being practiced or carried out in a variety of ways. It is to be understood that the phraseology and terminology employed herein is for the purpose of description and does not impose limitation on the present invention.

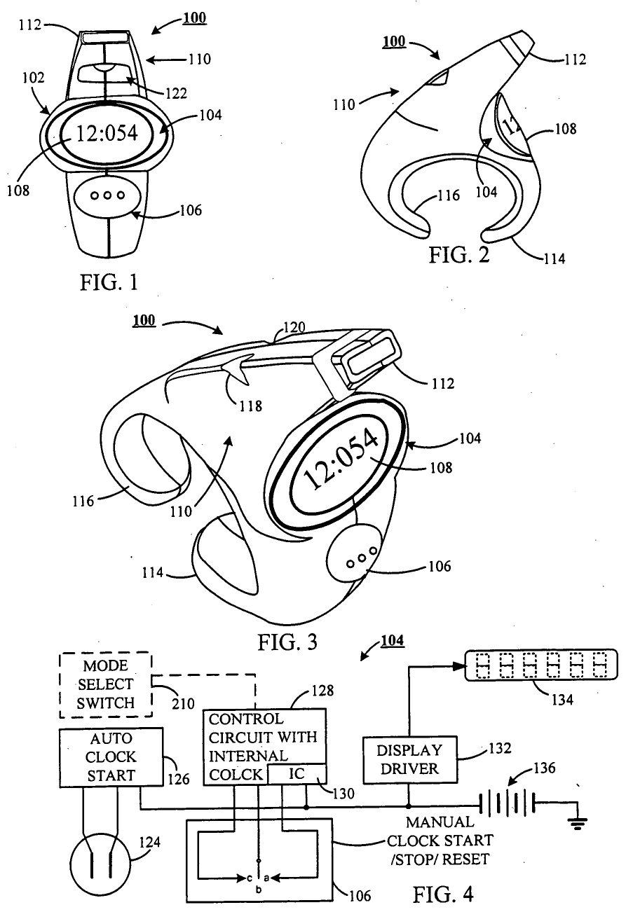

Referring now to the drawings, wherein like reference numerals indicate the same parts throughout the several views, a first combination whistle and stopwatch (“first combination”) 100 is shown in FIG. 1. Not by way of limitation, but by way of illustration only, the first combination 100 is particularly useful for officiating sporting events. Typically, a first preferred embodiment of the first combination 100 includes a housing 102 supporting a clock circuit (“clock”) 104 (display portion only shown). The housing 102, discussed in greater detail herein-below, may be constructed from composites, polymers, or other suitable material, and preferably takes the form of a structure assembled from a plurality of components. In the first preferred embodiment of the first combination 100, the clock 104, discussed in greater detail herein-below, typically includes at least a power source (such as battery 136 of FIG. 4), a manual clock start/stop/reset circuit (“SSR”) 106, and a display 108. In the first preferred embodiment, the housing 102 further includes an integrated audio frequency generating apparatus (“whistle”) 110, configured to respond to a user blowing into a mouth piece 112. In a second preferred embodiment of the first combination 100, the clock 104 further includes a frequency responsive activation circuit.

FIGS. 2 and 3 are best viewed in combination. FIG. 2 shows a first finger grip portion 114 and a second finger grip portion 116, while FIG. 3 shows a first and second audio frequency generating notches (“tone notches”) 118 and 120. A third audio frequency generating notch 122, is blocked from view in FIGS. 2 and 3, but is clearly visible in FIG. 1. Each tone notch, (118, 120, and 122 respectively), supports the generation of a tone of a predetermined frequency upon a blowing through the mouthpiece 112 by a user. The predetermined frequencies are selected to be slightly out of phase with one another. Through the incorporation of tone notches 118, 120, and 122, the whistle 10 is much like a harmonically tuned instrument because it produces three slightly different frequencies simultaneously. The different frequencies are superimposed on one another out of phase, and thus alternately reinforce and cancel out each other. The result is a loud, piercing vibrato generated without the need of moving parts.

Preferably, when a user selects an automatic mode for operating the first combination 100, (i.e., operating the first combination 100 as a second embodiment of the first combination 100), one of the three frequencies produced by the tone notches 118, 120, and 122 has been previously selected as the frequency used for starting and stopping the clock circuit 104. Because of the canceling out of the selected frequency by the remaining two frequencies, a sampling technique is incorporated within the clock 104. When a user activates, i.e., stops, the clock 104, by blowing in the mouthpiece 112, the clock 104 remains off as long as the samples continue to arrive at a predetermined rate, and until the samples fail to arrive at all for a predetermined period of time (i.e., the user stopped blowing in the mouthpiece). If it is so desired to utilize a start function by whistle, following the predetermined period of time, the clock 104 may be configured to reset its sampling circuit in anticipation of the user's reactivation of the clock 104, which can be set to occur upon a first detection of the selected frequency resulting from the user blowing a second time on the mouthpiece 112.

FIG. 4 shows that the clock 104, useful for operating the first combination 100 in the automated mode, includes a frequency pick-up 124 responsive to the selected frequency provided by the whistle 110, of FIG. 1, and communicating with an auto start clock circuit 126. The auto start clock circuit 126 interacts with a control circuit (“controller”) 128, with an internal clock (“IC”) 130, as described hereinabove. The SSR 106 communicates with the controller 128 to interact with the IC 130 to: place the IC 130 in a count-up mode, or a count-down mode; pause the IC 130, or resume the IC 130; or to reset or stop the IC 130. It is noted however; that neither the frequency pick-up 124, nor the auto start clock circuit 126, are included in the manually operated first preferred embodiment of the first combination 100.

Continuing with FIG. 4, by depressing the center portion of the SSR 106 once, the IC 130 starts in the count-up mode. Depressing the center portion of the SSR 106 twice starts the IC 130 in the count-down mode. Depressing the left portion of the SSR 106 once, pauses the IC 130, while depressing the left portion of the SSR 106 twice resumes the IC 130. Depressing the right portion of the SSR 106 once resets the IC 130, while depressing the right portion of the SSR 106 twice stops the IC 130. The status of the IC 130 is communicated by the controller 128 to a display driver 132 that drives a display element 134, which visually displays the current status of the IC 130. The various circuits of the clock 104 are preferably powered by a battery 136, selected for durability and long life.

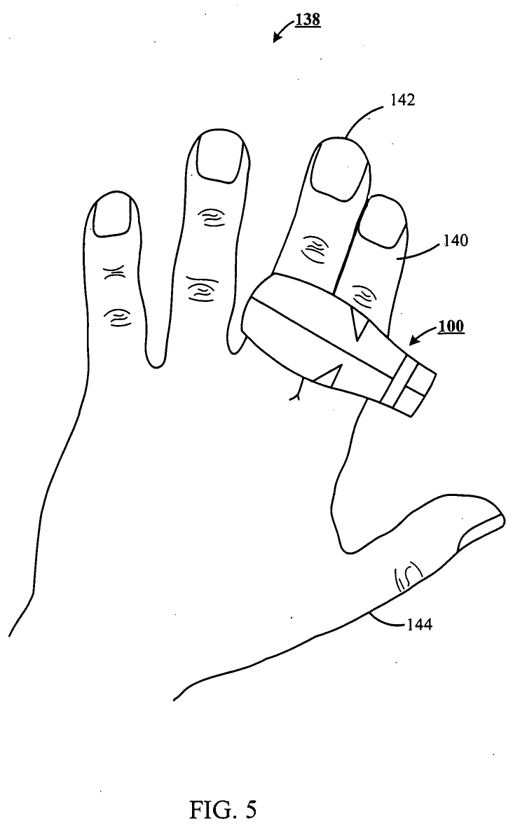

FIG. 5 shows a hand 138 of a user with the first combination 100 worn on index finger 140 and adjacent middle finger 141 of the hand 138. Although not a limitation on the present invention, supporting the first combination 100 on the index finger 140 and adjacent middle finger 141 is the preferred placement of the first combination 100. Such a placement permits easy access to the SSR 106 through use of the user's thumb 142.

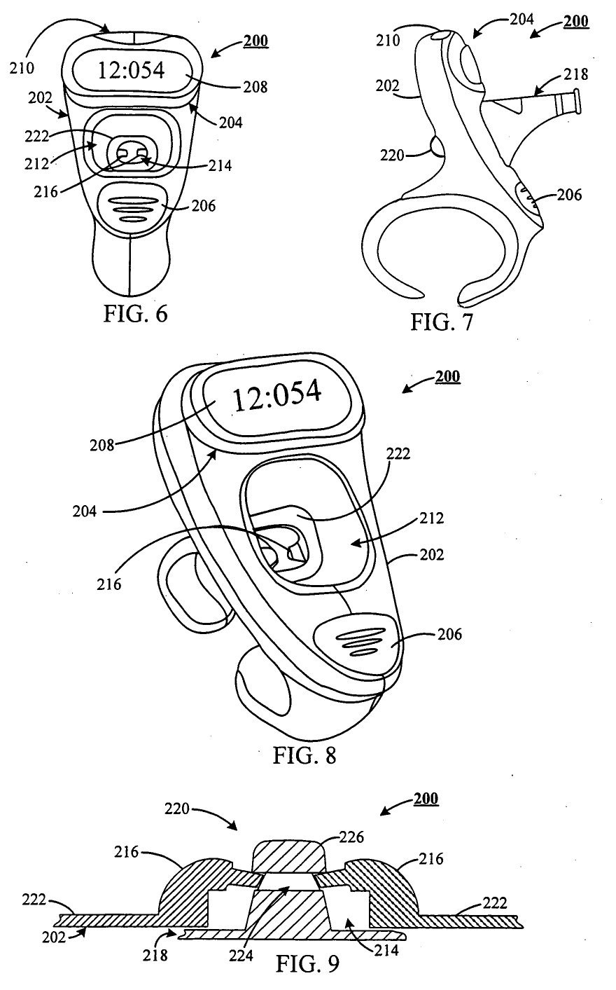

FIG. 6 shows a second combination whistle and stopwatch (“second combination”) 200. Not by way of limitation, but by way of illustration only, the second combination 200 is also particularly useful for officiating sporting events. The second combination 200 includes a first preferred embodiment (which operates in a manual mode), and a second preferred embodiment (which operates in an automated mode). Typically, the second combination 200 includes a housing 202 supporting a clock circuit (“clock”) 204 (display portion shown). The housing 202, discussed in greater detail herein-below, may be constructed from composites, polymers, or other suitable material, and preferably takes the form of a solid structure assembled from a plurality of components.

In the first preferred embodiment of the second combination 200, the clock 204, discussed in greater detail herein-below, typically includes at least a power source 136 of FIG. 4; a manual clock start/stop/reset circuit (“SSR”) 206; a display 208. In a second preferred embodiment of the second combination 200, the clock 204 further includes the frequency responsive activation circuit, which includes the frequency pick-up 124 and the auto start clock circuit 126, each of FIG. 4. Both the first and second embodiments of the second combination 200 include a mode select switch (“MSS”) 210 (also shown in FIG. 4 by dashed lines). Preferably, in the second combination 200, the MSS 210 toggles the controller 128 of FIG. 4, to operate the display 208 in either a chronographic watch mode, or a stopwatch mode.

By depressing the center of the MSS 210 once, the controller 128 of FIG. 4 directs the display driver 132, of FIG. 4, to toggle between the chronographic watch mode and the stopwatch mode, depending on which mode the clock 204 is then operating. When the clock 204 is operating in the stopwatch mode, the SSR 206 operates in substantially the same manner as described hereinabove for the operation of SSR 106, of FIG. 1. When the clock 204 is operating in the chronographic watch mode, the MSS 210 and the SSR 206 operate in conjunction to set the: hours; minutes; alarm time; month; day; year; and time zone. With the display 208 facing the user, by depressing the left side of the MSS 210 once, the user is able to set the hour of the day. Depressing the left side of the SSR 206 decreases the displayed hour, while depressing the right side of the SSR 206 increases the displayed hour. Depressing the left side of the MSS 210 a second time allows the user to set the minutes of the hour. Again the SSR 206 is used to increase or decrease the value of the minutes displayed. Depressing the left side of the MSS 210 a third time allows for setting the hour portion of an alarm time, while depressing the left side of the MSS 210 a forth time permits the minutes of the alarm time to be set.

Continuing with FIG. 6, the housing 202 further includes a whistle confinement chamber 212, a whistle snap retention aperture 214, and a pair of deflection tabs 216 protruding into the whistle snap retention aperture 214. The deflection tabs 216 are provided to retain an audio frequency generating apparatus.

As shown by FIG. 7, in a preferred embodiment of the second combination 200, the audio frequency generating apparatus is provided by a whistle 218. It is noted that the whistle 218 of FIG. 7, operates in substantially the same manner as the operation of whistle 110 of FIGS. 1-3, described hereinabove. It is further noted that for the second preferred embodiment of the second combination 200, the whistle 218 interacts with the clock 204 in substantially the same way that the whistle 110 of FIG. 1, interacts with the clock 106 of FIG. 1 as described hereinabove for the second embodiment of the first combination 100. FIG. 7 further shows a whistle snap retainer 220 of the whistle 218. The whistle snap retainer 220 interacts with the pair of deflection tabs 216 of FIG. 8, to retain the whistle 218 securely adjacent to the housing 202 during operation of the second combination 200.

FIG. 8 shows that the display 208 of the clock 204 is positioned above the whistle confinement chamber 212. Placement of the clock 204 promotes the inclusion of the MSS 210 of FIG. 7. For the second preferred embodiment of the second combination 200, the clock 204 substantially comprises the circuits shown by FIG. 4, including the MSS 210 shown by dashed lines and the battery 136. It is noted however; that neither the frequency pick-up 124, nor the auto start clock circuit 126, are included in the manually operated first preferred embodiment of the second combination 200.

Continuing with FIG. 9, each deflection tab 216 is supported by a whistle base support region 222 of the housing 202. The pair of retention tabs 216 engage a retention channel 224 of the whistle snap retainer 220 just below a retention button 226 to preclude the whistle snap retainer 220 from becoming inadvertently dislodged from the whistle snap retention aperture 214. By firmly retaining the whistle snap retainer 220, the whistle 218 is retained within the whistle confinement chamber 212 of the housing 202 of FIG. 8.

Additional renderings of another alternative integral design are shown in FIGS. 11-18.

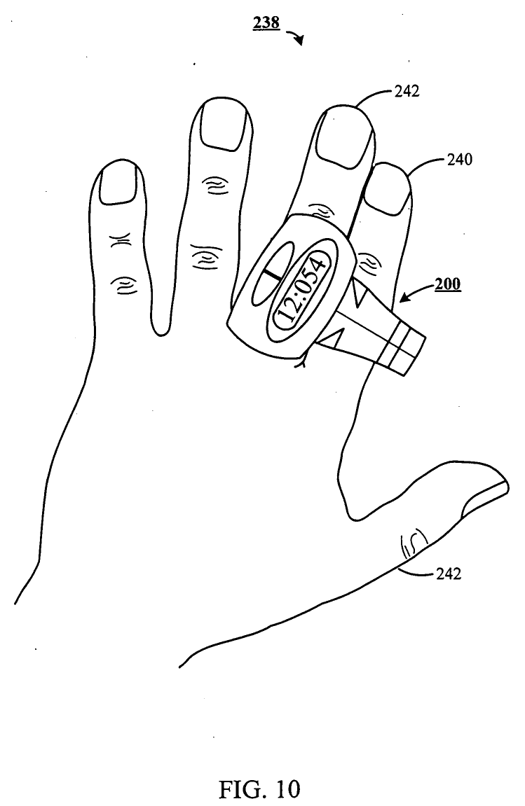

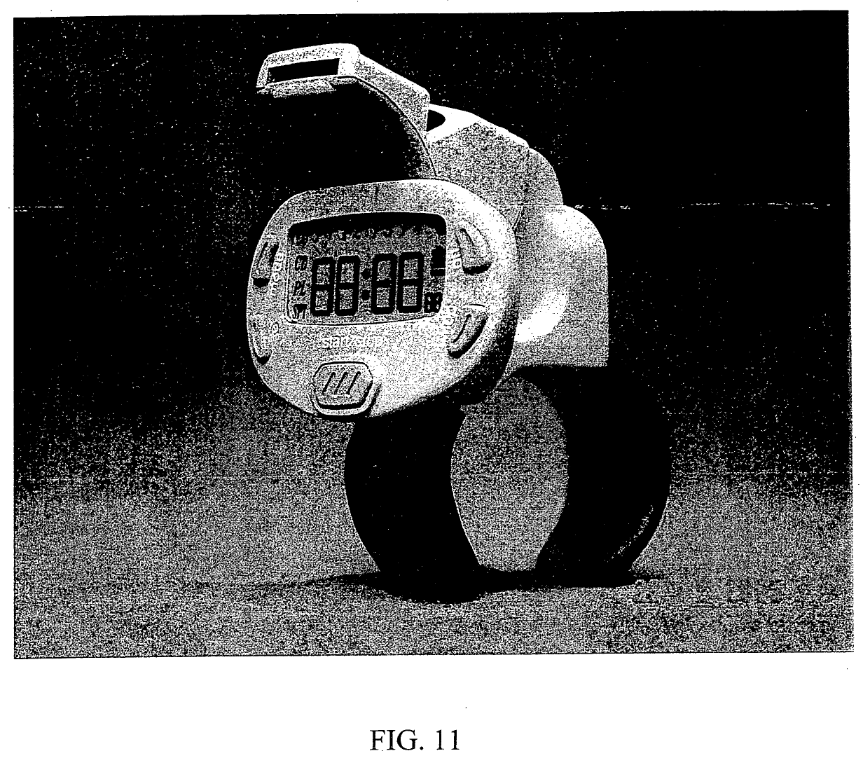

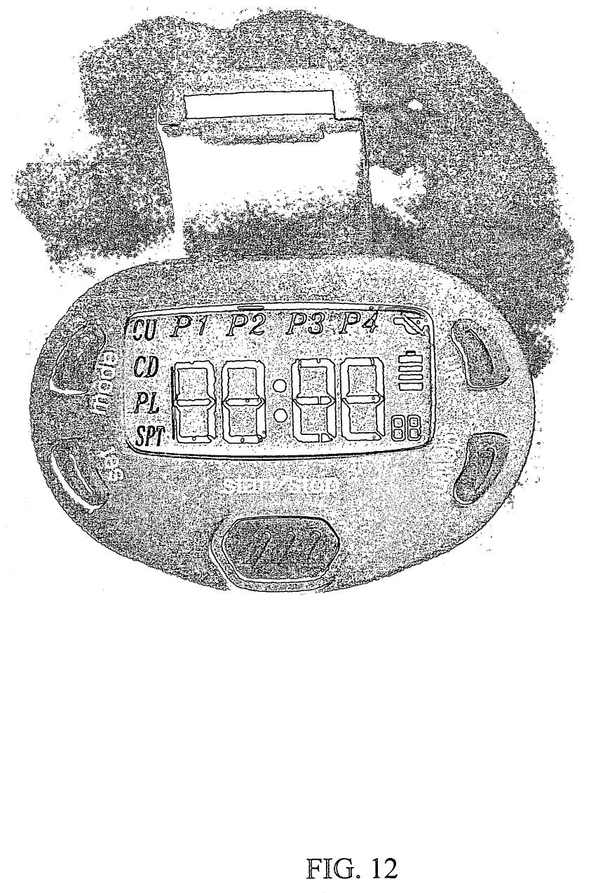

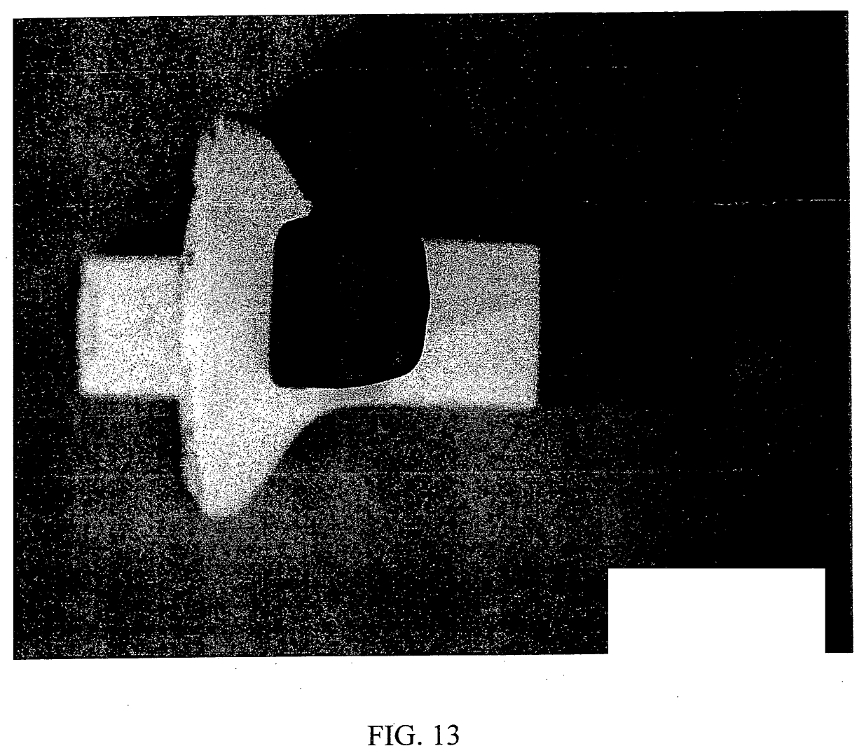

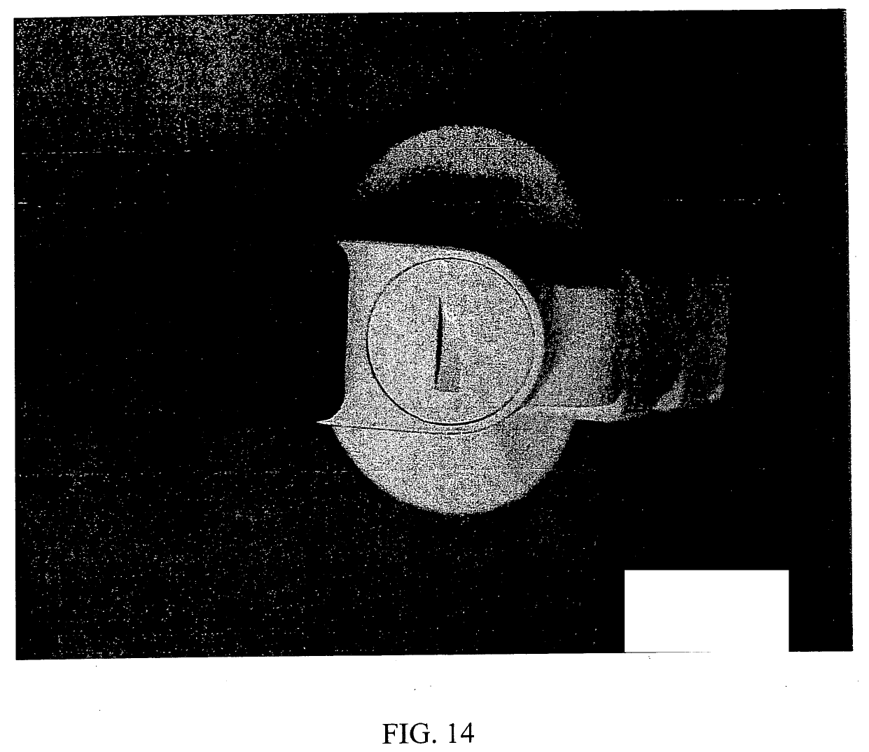

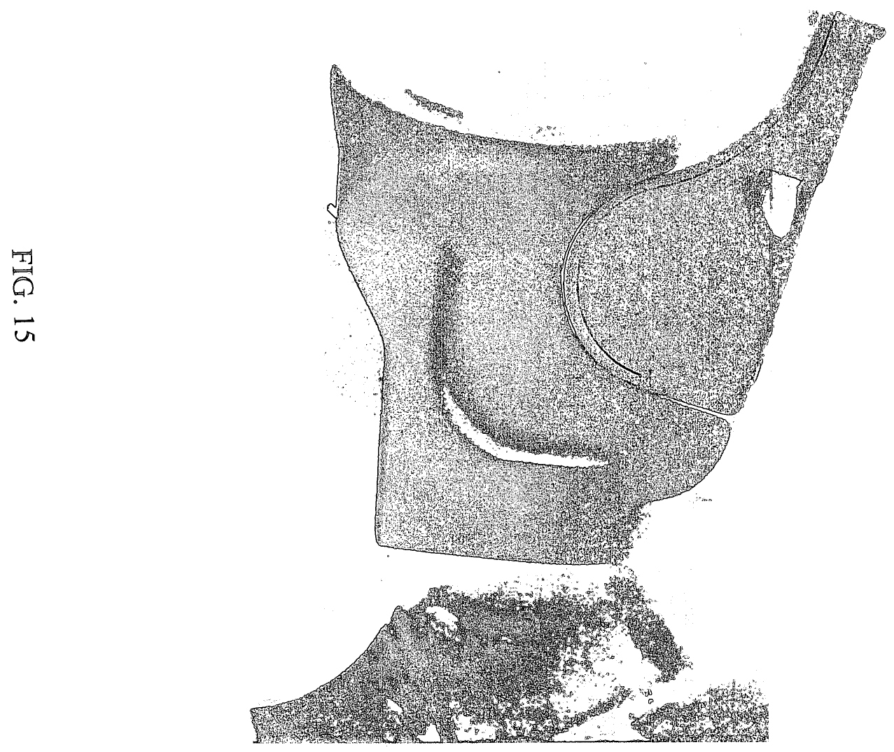

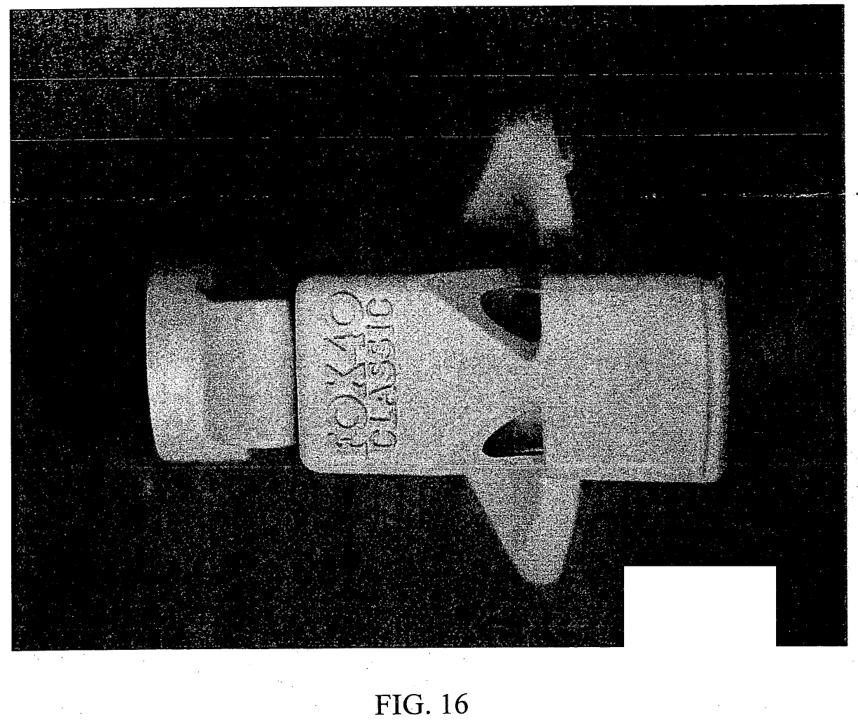

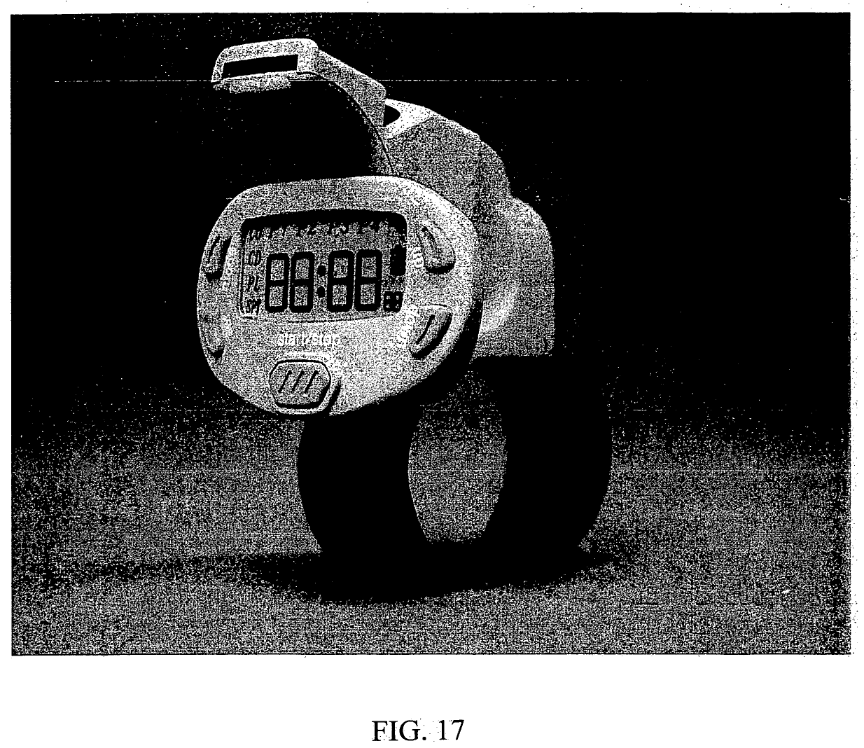

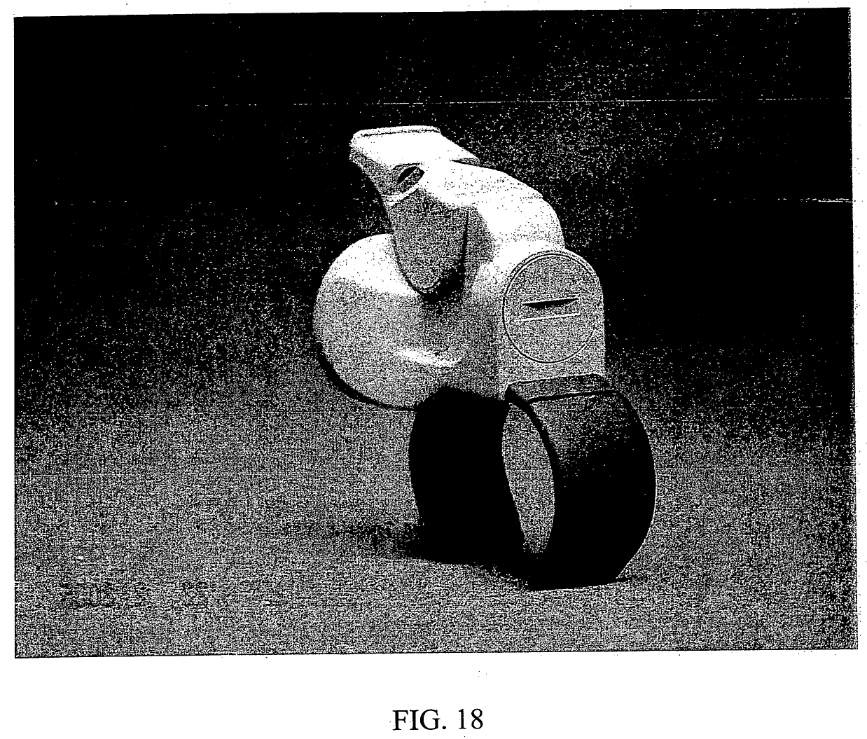

FIG. 10 shows a hand 238 of a user with the second combination 200 worn on an index finger 240 and adjacent middle finger 241 of the hand 238. Although not a limitation on the present invention, supporting the second combination 200 on the index finger 240 and adjacent middle finger 241 is the preferred placement of the second combination 200. Such placement permits easy access to the SSR 206, of FIG. 8, by the user through use of the users thumb 242.

As will be apparent to those skilled in the art, a number of modifications could be made to the preferred embodiments which would not depart from the spirit or the scope of the present invention. Thus, the present invention is well adapted to carry out the objects and attain the ends and advantages mentioned above as well as those inherent therein. While the presently preferred embodiments have been described for purposes of this disclosure, numerous changes and modifications will be apparent to those skilled in the art. Such changes and modifications are encompassed within the spirit of this invention.

What is claimed is:

1. A combination comprising:
a housing confining a clock circuit; and
an audio frequency generating apparatus integrated into the housing.

2. The combination of claim 1, in which said housing further comprising a first finger grip portion and the second finger grip portion, wherein said first and second finger grip portions cooperate to constrain said clock circuit and audio frequency generating apparatus in a predetermined orientation relative to a hand of a user of the combination.

3. The combination of claim 2, in which said housing further comprising a mouth piece portion for activation of said audio frequency generating apparatus in response to said user blowing a sufficient amount of air through said mouth piece portion.

4. The combination of claim 3, in which said audio frequency generating apparatus comprising an audio frequency generating notch portion provided by said housing and responsive to said user blowing said sufficient amount of air through said mouth piece portion.

5. The combination of claim 4, in which the response of said audio frequency generating notch to said user blowing said sufficient amount of air through said mouth piece portion is generation of a tone of predetermined frequency.

6. The combination of claim 5, in which said audio frequency generating apparatus further comprising at least a second audio frequency generating notch portion provided by said housing and responsive to said user blowing said sufficient amount of air through said mouth piece portion, wherein said response of said second audio frequency generating notch to said user blowing said sufficient amount of air through said mouth piece portion is generation of a second tone of a second predetermined frequency plan wherein said predetermined frequency of said second tone is offset from said predetermined frequency of said tone.

7. The combination of claim 1, in which said clock circuit comprising:
a controller comprising an internal clock;
a clock start, stop, and reset circuit communicating with said controller and controlling functions of said internal clock;
a display driver communicating with said controller and responsive to a status of said internal clock; and
a display element responsive to set display driver displaying set status of said internal clock.

8. The combination of claim 7, in which said clock circuit further comprising a battery power in each said controller, display driver, and display element.

9. The combination of claim 8, in which said start, stop, and reset circuit comprising:
a center portion communicating with said internal clock, wherein said internal clock responds to a force applied to said center portion by initiating a count-up sequence;
else said internal clock responds to a plurality of sequential forces applied to said center portion by initiating a count-down sequence.

10. The combination of claim 9, in which said start, stop, and reset circuit further comprising, a left portion communicating with said internal clock, wherein following initiation of said count-up sequence said internal clock responds to a force applied to said left portion by pausing said count-up sequence, and wherein following pausing of said count-up sequence said internal clock responds to a plurality of forces applied to said left portion by resuming said count-up sequence.

11. The combination of claim 9, in which said start, stop, and reset circuit further comprising, a left portion communicating with said internal clock, wherein following initiation of said count-down sequence said internal clock responds to a force applied to said left portion by pausing said count-down sequence, and wherein following pausing of said count-down sequence said internal clock responds to a plurality of forces applied to said left portion by resuming said count-down sequence.

12. The combination of claim 9, in which said start, stop, and reset circuit further comprising, a right portion communicating with said internal clock, wherein following initiation of said count-up sequence said internal clock responds to a force applied to said right portion by resetting said count-up sequence, and wherein following resetting of said count-up sequence said internal clock responds to a plurality of forces applied to said right portion by stopping said count-up sequence.

13. The combination of claim 9, in which said start, stop, and reset circuit further comprising, a right portion communicating with said internal clock, wherein following initiation of said count-down sequence said internal clock responds to a force applied to said right portion by resetting said count-down sequence, and wherein following resetting of said count-down sequence said internal clock responds to a plurality of forces applied to said right portion by stopping said count-down sequence.

14. The combination of claim 7, in which said clock circuit further comprising:
an auto start circuit communicating with said controller, said auto start circuit toggles said internal clock between an activated state and a deactivated state in response to said predetermined frequency; and
a frequency pick-up providing a signal to said auto start circuit in response to said predetermined frequency generated by said user blowing said sufficient amount of air through said mouth piece, wherein said signal alerts said auto start circuit to toggle said internal clock between said activated and said deactivated states.

15. The combination comprising:
a first housing comprising a clock circuit; and
an audio frequency generating apparatus integrated into a second housing, wherein said second housing interacts with said first housing to secure said second housing securely adjacent said first housing.

16. The combination of claim 15, in which said first housing further comprising:
a whistle confinement chamber configured to accommodate said second housing; and
a pair of deflection tabs adjacent said whistle confinement chamber, and configured to provide a whistle snap retention aperture.

17. The combination of claim 16, in which said second housing comprises:
an exterior housing surface configured to conform with said whistle confinement chamber; and
a whistle snap retainer configured to reside within said whistle snap retention aperture and communicate with said pair of deflection tabs to constrain said exterior housing surface securely adjacent said whistle confinement chamber.

18. A combination comprising:
an audio frequency generating apparatus integrated into a housing; and
a clock circuit confined by said housing and activated by means for activating said clock circuit.

19. The combination of claim 18, in which said means for activating said clock circuit comprising:
a controller providing an internal clock; and
a start, stop, and reset circuit comprising:
a center portion communicating with said internal clock, wherein said internal clock responds to a force applied to said center portion by initiating a count-up sequence; else
said internal clock responds to a plurality of sequential forces applied to said center portion by initiating a count-down sequence.

20. The combination of claim 18, in which said means for activating said clock circuit comprising:
a controller providing an internal clock;
an auto start circuit communicating with said controller, said auto start circuit toggles said internal clock between an activated state and a deactivated state in response to said predetermined frequency; and
a frequency pick-up providing a signal to said auto start circuit in response to said predetermined frequency generated by said user blowing said sufficient amount of air through said mouth piece, wherein said signal alerts said auto start circuit to toggle said internal clock between said activated and said deactivated states.
